(19) United States
(12) Patent Application Publication
(10) Pub. No.: US 2024/0209466 A1
(43) Pub. Date: Jun. 27, 2024

(54) TRANSPORT APPARATUS, LINING MACHINE, SYSTEM AND METHOD FOR OPERATING A SYSTEM OF THIS TYPE

(71) Applicant: Primetals Technologies Austria GmbH, Linz (AT)

(72) Inventors: Jens KLUGE, Dresden (DE); Martin PICHLER, Feldkirch (AT); Dominik STRASSER, Neufurth (AT); Jakub SZCZECH, Linz (AT); Bernhard VORABERGER, Linz (AT)

(21) Appl. No.: 18/573,951

(22) PCT Filed: Jun. 20, 2022
(86) PCT No.: PCT/EP2022/066729

§ 371 Date: Dec. 22, 2023

(30) Foreign Application Priority Data
Jun. 25, 2021 (EP) 21181714.3

(51) Int. Cl. C21C 5/44; F27D 1/00; F27D 1/16

(52) U.S. Cl. CPC C21C 5/441; F27D 1/0003; F27D 1/1621; F27D 2001/0046; F27D 2201/00

(57) ABSTRACT

A lining machine that includes a base frame, a rail group, a feed apparatus, a lift apparatus and a working platform, the rail group being mechanically fastened to the base frame and the rail group having at least one rail arrangement. The lift apparatus has a roller carriage and a lift unit located on the roller carriage, the roller carriage being provided on the rail arrangement so as to be movable between an installation position and an operating position. The lift unit is connected to the working platform and is designed to lower the working platform into the converter via the converter opening, and the feed apparatus has a roller conveyor, one end of which ends at the lift apparatus.

### CROSS-REFERENCE TO RELATED APPLICATIONS

The present application is a national stage application of PCT/EP2022/066729, filed Jun. 20, 2022, which claims priority to European patent application EP21181714, filed Jun. 25, 2021, the contents of which are incorporated by this reference.

### FIELD OF INVENTION

The invention relates to a transport apparatus, a lining machine, a system that includes the lining machine, and a method for operating the system.

### BACKGROUND

A converter for steel production has a converter vessel with a lining on the inside. The lining serves to protect the converter vessel, which is made of steel, from the heat of the molten steel in a working space, which is delimited by the lining. During a blowing process that reduces the carbon content of the molten iron by injecting oxygen, the lining is subjected to high thermal stress and wears out with the number of blowing processes. When a certain number of blowing processes is reached, the converter lining must be replaced, as otherwise the converter vessel will be damaged by the molten steel, which has a temperature of from 1,600° ° C. to 1,750° C.

For example, a lining machine is known from U.S. Pat. No. 3,955,685 A. The lining machine has a plurality of working platforms. Furthermore, a crane is provided for lifting pallets of refractory material intended for lining a converter into the converter. The working platforms are arranged offset to each other in the circumferential direction of the lining machine. The pallets with the refractory material are lifted centrally by the crane. The lining machine protrudes over a floor of the converter into the converter. The pallet is transported from the crane to the respective working platform by means of a roller table.

U.S. Pat. No. 3,439,794 A describes a lining machine that is placed on top of the converter. In order to transport the refractory material, a conveyor belt is provided, by means of which the refractory material is transported into the converter from above.

### SUMMARY

It is the object of the invention to provide an improved transport apparatus, an improved lining machine, an improved system, and an improved method for operating a system of this type.

This object is achieved by means of a transport apparatus as claimed, a lining machine as claimed, a system as claimed, and a method as claimed according to claim 13. Advantageous embodiments can be found in the dependent claims.

It has been recognized that an improved transport apparatus can be provided in that the transport apparatus has a first transport space and a first roller table arranged below the first transport space for transporting a first item to be transported. The first roller table has a first roller frame, a second roller frame, a first roller arrangement with at least two first rollers and a second roller arrangement with at least one second roller. The second roller frame is arranged in the first roller frame so as to be movable along an axis between a first position and a second position different from the first position. Each of the first rollers is attached to the first roller frame so as to be rotatable about a first axis of rotation, which is inclined with respect to the axis. The second roller is arranged between the two first rollers. The second roller is mounted on the second roller frame so as to rotate about a second axis of rotation, which is aligned inclined with respect to the axis and to the first axis of rotation. The first roller has a first rolling surface on its circumference and the second roller has a second rolling surface on its circumference. In the first position of the second roller frame, the second roller is recessed between the two first rollers and the first rolling surface projects beyond the second rolling surface in the direction of the axis. In the second position, the second roller frame is raised relative to the first position and the second rolling surface projects beyond the first rolling surface in the direction of the axis.

This configuration has the advantage that, in the first position, the first rolling surface rests against the underside of the first item to be transported, for example a pallet or a person on a standing platform, and the first item to be transported is arranged on the first roller table in the first transport space so that it can be moved in a first direction. This allows the first item to be transported to be removed from the first transport space in the first direction. In the second position, the second rolling surface rests against the underside of the first item to be transported. The first item to be transported is arranged on the first roller frame so that it can be moved in a second direction different from the first direction.

The first item to be transported can be removed from the first transport space in the second direction.

The option of removing the material to be transported from the first transport space in two directions offers the possibility of flexibly providing, with a short travel path, the material to be used on a working platform of a lining machine.

In a further embodiment, the transport apparatus has at least a first removal table and a second removal table arranged offset to the axis in the circumferential direction. The first removal table has a third roller arrangement with at least one third roller and a third roller frame, wherein the third roller is attached to the third roller frame so as to be rotatable about a third axis of rotation. The second removal table has a fourth roller arrangement with at least a fourth roller and a fourth roller frame, wherein the fourth roller is attached to the fourth roller frame so that it can rotate about a fourth axis of rotation. The third axis of rotation is parallel to the first axis of rotation and the fourth axis of rotation is parallel to the second axis of rotation. This configuration has the advantage that, in the first position, the first item to be transported can easily be pulled out from the first transport space via the first rollers and the third rollers. In the second position, i.e., when the first item to be transported is resting on the second rollers, the first item to be transported can be pulled out in the second direction onto the second removal table, wherein the second rollers and the fourth rollers support the underside of the first item to be transported. This allows the first item to be transported to be flexibly removed from the transport space and made available for installing the lining of the converter.

In a further embodiment, the transport apparatus has a housing with a closable first housing opening and a closable second housing opening that is offset from the first housing opening in the circumferential direction with respect to the axis. The housing encloses the first transport space at least in portions. The first housing opening is arranged between the first removal table and the first transport space and the second housing opening is arranged between the second removal table and the first transport space. The closable housing openings prevent the first item to be transported from slipping out of the first transport space via the housing openings during transportation of the first item to be transported.

In a further embodiment, the transport apparatus has a second transport space and a second roller table, wherein the second roller table is arranged offset along the axis with respect to the first roller table and closes off the top of the first transport space. Furthermore, the second roller table delimits the second transport space on the underside. The second roller table has a fifth roller frame and a fifth roller arrangement with at least one fifth roller, wherein the fifth roller is attached to the fifth roller frame so as to be rotatable about a fifth axis of rotation. The fifth axis of rotation is arranged parallel to the first axis of rotation. This configuration has the advantage that the second item to be transported can be drawn from the first transport space onto the first removal table via the first housing opening.

In a further embodiment, the first removal table has a lifting unit, wherein the lifting unit is connected to the third roller frame. The lifting unit is designed to move the third roller frame between a first removal position and a second removal position that differs from the first removal position. In the first removal position, the first roller arrangement and the third roller arrangement are arranged substantially at the same height. In the second removal position, the fifth roller arrangement and the third roller arrangement are arranged substantially at the same height. This configuration has the advantage that the respective item to be transported can be removed from both the first transport space and the second transport space by means of the lifting apparatus. Furthermore, the working height can be flexibly and ergonomically adjusted for a worker.

In a further embodiment, the first roller table has an unloading opening, wherein the first transport space is accessible through the unloading opening and the first item to be transported can be unloaded through the unloading opening, wherein at least the first roller arrangement and the second roller arrangement are arranged to the side of the unloading opening. As a result, the first item to be transported can also be provided underneath the working platform in a simple manner.

An improved lining machine for renewing a lining of a converter through a converter opening can be provided in that the lining machine comprises a base frame, a rail group, a feed apparatus, an elevator apparatus and a working platform, wherein the rail group is mechanically attached to the top of the base frame. The rail group has at least one rail arrangement, wherein the elevator apparatus has a roller carriage and an elevator unit arranged on the roller carriage. The roller carriage is arranged on the rail arrangement so as to be movable between an installation position and an operating position. The elevator unit is connected to the working platform and is designed to lower the working platform into the converter via the converter opening. The feed apparatus has a roller conveyor, one end of which ends at the elevator apparatus. The advantage of this design is that the modular structure of the lining machine means that the lining machine can be assembled and disassembled particularly quickly and the converter can therefore be put back into operation particularly quickly. In a production plant with multiple converters, the linings of the converters can also be renewed one after the other by means of the lining machine, wherein the lining machine is assembled and disassembled at the converter to be renewed in each case.

In a further embodiment, the lining machine has a transport apparatus which is designed as described above. Furthermore, the transport apparatus has a further elevator unit, wherein the further elevator unit is connected to the first roller table and is designed to move the first roller table between the first position and the second position.

In a further embodiment, the further elevator unit has a second winch, wherein the second winch is mechanically connected to the first roller table by means of a second cable. The second winch is designed to wind or unwind the cable in order to move the first roller table between the first position and the second position. This configuration has the advantage that the lining machine is particularly cost-effective.

In a further embodiment, the rail group has a carrier frame and a leveling apparatus, wherein the carrier frame is mechanically connected to the base frame. The rail arrangement is arranged on the carrier frame. The leveling apparatus has a first leveling unit.

The leveling unit has at least one first leveling element, which is attached to the carrier frame on a first side. On a second side, facing away from the first side, the first leveling element is designed to rest against a converter vessel. The first leveling element is designed to be adjustable in such a way that a distance between the first side and the second side can be changed. For example, the first leveling element can be a hydraulic cylinder, an electric adjusting cylinder or a manual threaded spindle. By means of the first leveling element, the carrier frame can be aligned in a defined manner, for example in a horizontal direction exactly with the converter vessel, so that unintentional rolling of the roller carriage on the rail arrangement without a brake is prevented. It is also ensured that the elevator unit moves coaxially to the vertical axis of the converter. Furthermore, this prevents the lining machine from tilting, for example in the operating position, by supporting the first leveling element on the second side of the converter vessel. Additionally or alternatively, the levelling device has at least one second levelling unit, wherein the second levelling unit has at least one second levelling element, which is arranged on a third side on the base frame, wherein the second levelling element rests against the connecting platform on a fourth side facing away from the third side, wherein the second levelling element is adjustable in such a way that a distance between the third side and the fourth side can be changed in order to pivot the connecting platform relative to the base frame. This allows the connecting platform to be precisely aligned with the converter and ensures complete overlap of the working opening with the converter opening.

An improved system can be provided in that the system comprises a converter and a lining machine. The lining machine is formed as described above. The converter has a converter vessel with a converter opening, wherein the converter vessel encloses a converter chamber which is open at the top through the converter opening. The base frame is arranged laterally in front of the converter vessel. The rail group is arranged above the base frame and the converter opening. In the installation position, the elevator apparatus is arranged above the base frame and in the operating position above the converter opening. In the operating position, the elevator apparatus is designed to lower the working platform into the converter chamber. This configuration has the advantage that the lining can be replaced particularly quickly. Furthermore, the lining machine can be used for multiple converters.

In a further embodiment, the second side of the leveling element rests against the converter vessel and supports the carrier frame on the converter vessel. The leveling element is designed to align the carrier frame in relation to the base frame and the converter vessel. This ensures precise alignment of the rail arrangement.

An improved method for operating a system designed as described above can be provided by placing the base frame in front of the converter. The rail group is placed on the base frame and the converter in such a way that the rail group runs at least in portions along the converter opening. The rail group is connected to the base frame in a mechanically reversible and detachable manner. The elevator apparatus is placed on the rail group in such a way that the roller carriage is positioned on the rail group in the mounting position. The elevator apparatus is moved into the operating position. The feed apparatus is positioned on the rail group in such a way that one end of the feed apparatus is positioned at the converter opening and at the elevator apparatus. The working platform is lowered into the converter chamber via the converter opening. The advantage of this configuration is that the modular structure makes the operating procedure for operating the system particularly simple and the lining operation can be started particularly quickly.

In a further embodiment, the first roller table is moved to a third position, wherein a first item to be transported is fed to the feed apparatus and the first item to be transported is moved on the roller conveyor to the first roller table. The first item to be transported is moved on the first roller table into the first transport space. Here, the first roller rolls along the first item to be transported. The elevator apparatus lowers the first roller table into the first position or into the second position. In the first position, the first item to be transported is removed from the first transport space in a first direction. In the second position, the first item to be transported is removed from the first transport space in a second direction. This configuration has the advantage that the first item to be transported can be removed from the first transport space in at least two directions in a particularly flexible manner—as required—so that the travel paths are particularly short. Furthermore, if one removal table is already occupied, the first item to be transported can be removed from the first transport space onto the second removal table.

In a further embodiment, the first roller table is lowered through an opening of the working platform into a fourth position below the working platform in such a way that the first transport space is arranged below the working platform, wherein the first transport space below the working platform is loaded and/or unloaded with the first item to be transported. This makes it easy to quickly provide the lining material below the working platform so that the lining below the working platform can be quickly renewed.

In a further embodiment, the carrier frame is arranged on the converter. The leveling element is brought into contact with the converter vessel and the carrier frame is brought into a predefined position with the leveling element. This ensures a defined alignment of the carrier frame relative to the converter vessel and the base frame.

### BRIEF DESCRIPTION OF THE FIGURES

The invention is explained in greater detail below with reference to the figures, in which:

FIG. 1 shows a sectional view through a system;

FIG. 2 shows a perspective view of the lining machine;

FIG. 3 shows a perspective view of the base frame;

FIG. 4 shows a perspective view of the rail group;

FIG. 5 shows a side view of the rail group shown in FIG. 5;

FIG. 6 shows a perspective view of an elevator apparatus of the lining machine;

FIG. 7 shows a detail of a perspective view of the working platform and the transport apparatus, wherein the working platform is only partially shown;

FIG. 8 shows a perspective view of the transport apparatus,
wherein, for reasons of clarity, numerous components are not shown;

FIG. 9 shows a detail of the first roller table shown in FIG. 8 in a variant;

FIG. 10 shows a detail of a sectional view along a sectional plane A-A shown in FIG. 9 through the first roller table;

FIG. 11 shows the detail of the first roller table shown in FIG. 9;

FIG. 12 shows a sectional view along the sectional plane A-A shown in FIG. 11 through the first roller table;

FIG. 13 shows a top view of the working platform and the transport apparatus;

FIG. 14 shows a top view of a second roller table of the transport apparatus;

FIG. 15 shows a perspective view of the transport apparatus on the working platform;

FIG. 16 shows a flow chart of a method for renewing a lining of a converter of the system;

FIG. 17 shows a perspective view of the base frame on the converter during a second method step;

FIG. 18 shows a perspective view of the system during a third method step;

FIG. 19 shows a perspective view of the system during a fourth method step;

FIG. 20 shows a perspective view of the system during a fifth method step;

FIG. 21 shows a perspective view of the elevator apparatus together with the transport apparatus and the working platform during a sixth method step;

FIG. 22 shows a perspective view of the system; and

FIG. 23 shows a perspective view of the transport apparatus and the working platform in a development of the system.

### DETAILED DESCRIPTION

In the following figures, reference is made to a coordinate system for easier understanding. The coordinate system has an x-axis (longitudinal direction), a y-axis (transverse direction) and a z-axis (height direction). The coordinate system is designed as a right-hand system by way of example.

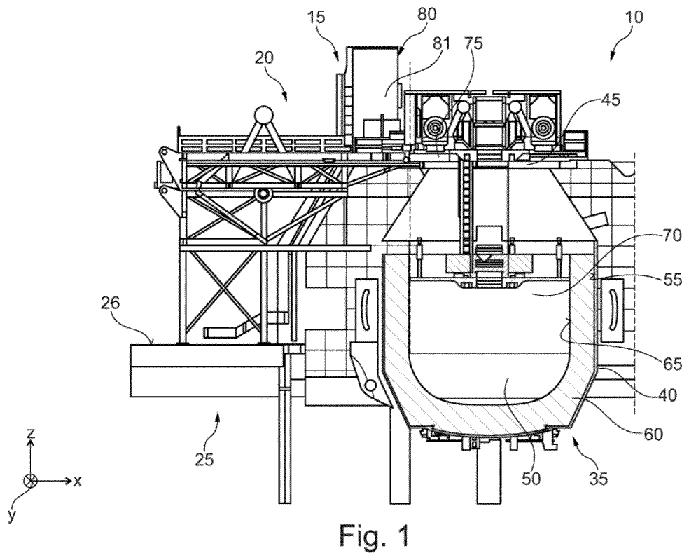

FIG. 1 shows a sectional view through a system 10.

The system 10 has a production plant 15 and a lining machine 20. The production plant 15 has a building 25 with a building floor 26 and a crane 30 installed in the building 25 (not shown in FIG. 1) as well as at least one converter 35. The production plant 15 can in particular have several, preferably identically designed, converters 35 arranged next to each other at a distance in the y-direction. Each of the converters 35 is designed to receive a liquid iron melt. A Linz-Donawitz process, for example, is carried out in the converter 35 to produce a molten steel from the molten iron.

The converter 35 has a converter vessel 40 with a converter opening 45, wherein the converter opening 45 is arranged on the upper side of the converter vessel 40. The converter vessel 40 encloses a converter chamber 50, wherein a lining 60 of the converter 35 is arranged in the converter chamber 50 on the inner side, adjacently to a first inner peripheral side 55 of the converter vessel 40. With a second inner circumferential side 65, the lining 60 delimits a working space 70, which in normal operation of the converter 35 is at least partially filled with the molten iron or with the molten steel produced from the molten iron.

The converter vessel 40 tapers in the z-direction towards the converter opening 45. The converter opening 45 can, for example, have a circular cross-section.

The converter 35 also has a converter frame 75, wherein the converter vessel 40 is attached to the converter frame 75. In order to collect waste gas during the production of the molten steel, the converter 35 has an enclosure 80. The enclosure 80 has an enclosure opening 81, which is open in FIG. 1 and in which the lining machine 20 engages.

During the production of the molten steel from the molten iron, the lining 60 wears away with each oxygen blowing process into the molten iron. The lining 60 must therefore be renewed at regular intervals. In order to renew the lining 60 particularly quickly and to provide the converter vessel 40 with a new lining 60, the lining machine 20 described below is used.

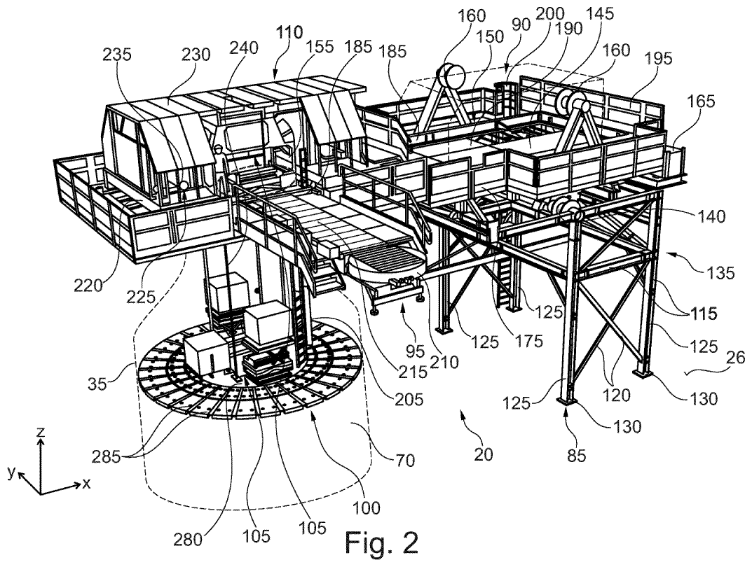

FIG. 2 shows a perspective view of the lining machine 20.

In FIG. 2, the converter 35 is not shown for reasons of clarity. The lining machine 20 has a base frame 85, a rail group 90, a feed apparatus 95, a working platform 100, a transport apparatus 105 and an elevator apparatus 110.

In FIG. 2, the working platform 100 is lowered into the working space 70 of the converter 35 in the same way as in FIG. 1. With respect to the x-axis, the working platform 100 is laterally offset relative to the base frame 85 and is arranged at the height of the base frame 85 in the z-direction. The transport apparatus 105 is arranged on the working platform 100.

In FIG. 2, the elevator apparatus 110 is arranged in an operating position. In the operating position, the elevator apparatus 110 is arranged above the converter vessel 40, in particular the converter opening 45. Furthermore, the elevator apparatus 110 may be arranged in an installation position. In the mounting position (shown in dashed lines in FIG. 2), the elevator apparatus 110 is arranged laterally offset from the converter opening 45.

The feed apparatus 95 is arranged laterally adjacently to the converter opening. The feed apparatus 95 extends substantially in the y-direction and ends on one side in the region of the converter opening 45 and the elevator apparatus 110. The feed apparatus 95 has a turntable 210 and a roller conveyor 215. The turntable 210 is arranged on a side of the roller conveyor 215 facing away from the elevator apparatus 110. The turntable 210 can be rotated about the z-axis. On the underside, the feed apparatus 95 can be supported on the converter frame 75 and/or the enclosure 80.

The roller conveyor 215 and the turntable 210 are arranged in a common plane, which is preferably formed as an xy-plane. The roller conveyor 215 and/or the turntable 210 can be positioned on the enclosure 80, for example on a moving plane that is elevated relative to the building floor 26. The feed apparatus 95 and the rail group 90 are arranged at a similar height above the building floor 26.

A second ladder 205 (cf. FIG. 2) may be provided between the work floor 190 and the working platform 100 to enable personnel to access the working platform 100 from the work floor 190.

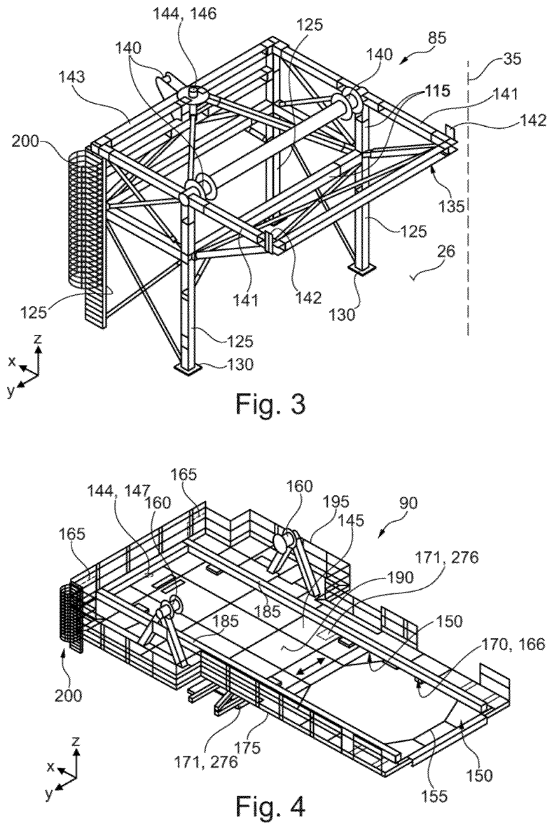

FIG. 3 shows a perspective view of the base frame 85.

The base frame 85 is designed as a framework comprising several profiled beams 115, which are bolted or welded together. In the embodiment, four vertical, upright profiled beams 115 are formed as supports 125. A fastening plate 130 is arranged, for example welded, on the underside of each of the supports 125. The fastening plate 130 is connected to the building floor 26, for example. For this purpose, for example, the fastening plate 130 can be screwed to a predefined fastening point of the building floor 26.

A support frame unit 135 of the base frame 85 is attached to the top of the supports 125 and is formed in the manner of a framework from the profile beams 115 and has a trapezoidal configuration in a side view. In the x-direction, the support frame unit 135 protrudes beyond the supports 125 on a side facing the converter 35.

The support frame unit 135 has at least one, preferably three, first attachment points 140 arranged at a distance from one another on the upper side, wherein, for example, two of the first attachment points 140 are arranged in the x-direction at the level of the two supports 125 arranged closest to the converter 35. The further first attachment point 140 can be arranged on a side facing away from the converter 35. For example, the crane 30 can be attached to the first attachment point 140 in order to lift the base frame 85. Furthermore, the rail group 90 is attached to the top of the support frame unit 135 (cf. FIG. 2).

Two profiled beams 115 of the support frame unit 135 extending in the longitudinal direction and arranged at the top each form a longitudinal beam 141. Each of the longitudinal beams 141 projects on one side in the x-direction beyond the support 125 which supports the longitudinal beam 141 on the underside. A stop 142 is arranged laterally on each of the longitudinal beams 141 and projects above the longitudinal beam 141.

The support frame unit 135 also has a profiled beam 115 extending in the y-direction, which forms a cross member 143. The cross member 143 is arranged on the upper side of two supports 125 and is connected to the supports 125. The cross member 143 connects the two longitudinal beams 141 in the y-direction. The cross member 143 is arranged on the side facing away from the converter 35. On this side, for example, the longitudinal beams 141 are flush with the supports 125 in the x-direction. A first part of a swivel joint 144 is arranged on the upper side in the transverse direction, for example in a central position. The first part of the swivel joint 144 can, for example, be designed as a cylindrical pin 146 extending in the z-direction.

FIG. 4 shows a perspective view of the rail group 90.

FIGS. 2 and 4 are explained together below. The rail group 90 has a connecting platform 145, a rail arrangement 150, a working opening 155 (schematically indicated by dashed lines in FIG. 2), a second attachment point 160, preferably at least one pair of second attachment points 160 arranged opposite one another in the y-direction, a counterweight 165 and a leveling apparatus 166.

The leveling apparatus 166 has a first leveling unit 170 and a second leveling unit 171. The first leveling unit 170 is used to align the rail group 90 relative to the converter 35 and the base frame 85 in the z-direction and about the x-axis and y-axis. The second leveling unit 171 is used to align the rail group 90 about the z-axis and to swivel the rail group 90 about the z-axis by means of the bearing on the swivel joint 144.

The connecting platform 145 has a carrier frame 175. The carrier frame 175 is formed like a framework from profiled steel elements and is reversibly detachably connected to the support frame unit 135 by means of a mechanical connection. The carrier frame 175 is arranged on the top of the support frame unit 135 and projects beyond the support frame unit 135 in the x-direction on the side facing the converter 35. The carrier frame 175 supports the connecting platform 145 on the underside of the support frame unit 135. Furthermore, the rail arrangement 150 is attached to the carrier frame 175.

The rail arrangement 150 is partially concealed in FIGS. 2 and 4. The rail arrangement 150 has two rails 185 running parallel in the x-direction. A work floor 190 of the connecting platform 145 can be arranged to the side of the rail arrangement 150 in order to cover the top of both the carrier frame 175 and the base frame 85. The work floor 190 can be walked on. For work safety, a fall protection means 195 of the connecting platform 145, for example in the form of a railing, can be arranged on the periphery of the carrier frame 175. In addition, a first ladder 200 is arranged laterally on the carrier frame 175, for example on a side facing away from the converter 35, and extends to the work floor 190 in order to enable access from the building floor 26 to the work floor 190 for personnel to operate the lining machine 20. The first ladder 200 may be further guided on a support 125 up to the building floor 26 on the base frame 85 (cf. FIG. 3).

The working opening 155, which has approximately the same spatial extent as the converter opening 45, is arranged in the work floor 190. The working opening 155 and the converter opening 45 are arranged in alignment with one another.

On a side opposite the working opening 155 in the x-direction, the counterweight 165 is attached to the carrier frame 175. The counterweight 165 can have one or more plates, which are stacked in a pile. The counterweight 165 serves to prevent the rail group 90 and the base frame 85 from tilting about the y-axis in the direction of the converter 35.

The rails 185 are arranged as far apart as possible in the y-direction. For example, the spacing is selected to be at least so wide that the working opening 155 is arranged completely between the two rails 185. In the x-direction, the rails 185 extend substantially completely over a maximum total extent of the rail group 90. The second attachment point 160 can be arranged in an elevated position relative to the work floor 190, wherein the rail arrangement 150 extends between the pair of second attachment points 160. The second attachment points 160 are arranged, for example, on the side facing away from the working opening 155 as close as possible to the center of gravity of the rail group 90. The counterweight 165 can be dimensioned in such a way that when the rail group 90 is lifted at the two second attachment points 160, the work floor 190 is held substantially horizontally.

The swivel joint 144 has a second part that corresponds to the first part and is attached to the carrier frame 175. The second part can, for example, be designed as a joint receptacle 147 with a cylindrical opening in which the pin 146 engages in the assembled state (schematically indicated in FIG. 4). On the one hand, the swivel joint 144 supports downward forces in the z-direction on the cross member 143, and on the other hand it enables the carrier frame 175 to be guided about the z-axis on the base frame during assembly of the lining machine 20.

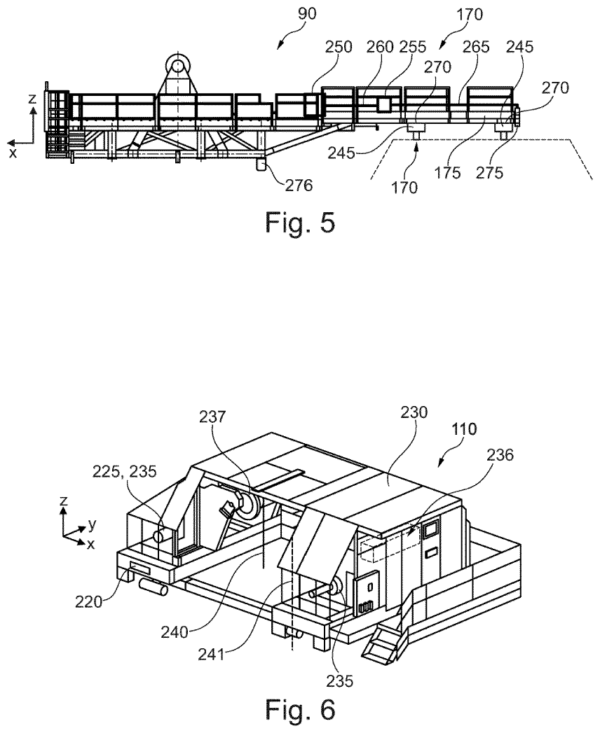

FIG. 5 shows a side view of the rail group 90 shown in FIG. 4.

On the underside, on the side facing away from the converter 35 (indicated by a dashed line in FIG. 5), the first leveling unit 170 is arranged on the carrier frame 175. The first leveling unit 170 has at least one first leveling element 245, a storage container 250, a feed pump 255 as well as a first fluid line 260 and at least one second fluid line 265. The storage container 250 can, for example, be filled with a pressurized medium, such as a hydraulic fluid. The storage container 250 is connected to the feed pump 255 by means of the first fluid line 260. On the output side, the feed pump 255 is connected to the first leveling element 245 by means of the second fluid line 265. The first leveling element 245 can, for example, have a hydraulic cylinder that can be moved in two directions.

The first leveling element 245 is mechanically connected to the carrier frame 175 on a first side 270. A second side 275 is displaceable relative to the first side 270, for example in the z-direction. Here, for example, in order to move the second side 275 out of the first leveling element 245, the feed pump 255 can remove the pressure medium from the storage container 250 and press it into the first leveling element 245 via the first and second fluid lines 260, 265. The second side 275 rests, for example, on the top side of the converter vessel 40 next to the converter opening 45. By means of the positioning of the second side 275 relative to the first side 270 of the first leveling element 245, a position in the z-direction of the carrier frame 175 and thus of the rail arrangement 150 and the work floor 190 can be precisely adjusted, so that the rail arrangement 150 is arranged substantially in a horizontal plane.

It should be noted that the first leveling unit 170 can of course also be designed differently. For example, the pressure medium can also be compressed air. Alternatively, an electrically operated first leveling element 245 would also be possible.

In the embodiment, the feed pump 255 is manually operated, for example. Of course, a mechanically driven feed pump 255 would also be possible.

In the embodiment, first leveling elements 245 are arranged on the carrier frame 175, for example at four points laterally around the working opening 155, and can be actuated individually in order to align a position of the carrier frame 175 in a defined manner with the converter 35 in the z-direction and about the x-axis and the y-axis. Furthermore, the first leveling unit 170 is designed such that the first leveling unit 170 can support forces from the rail group 90, in particular from the elevator apparatus 110, on the converter vessel 40.

The second leveling unit 171 has at least one second leveling element 276. The second leveling element 276 may, for example, have a hydraulic cylinder that is movable in two directions. It should be noted that the second leveling unit 171 can of course also be designed differently. For example, the pressure medium can also be compressed air. Alternatively, an electrically operated second leveling element 276 would also be possible. The second leveling element 276 extends between the stop 142 (cf. FIG. 3) and the carrier frame 175 and is supported on a third side on the stop 142 and on a fourth side on the carrier frame 175. The second leveling element 276 can be fluidically connected to the feed pump 255 via a third fluid line (not shown) and a valve. A distance between the third side and the fourth side can be changed by conveying the pressure medium into the second leveling element 276. As a result, the rail group 90 can be pivoted about the z-axis at the swivel joint 144 relative to the converter 35 and the base frame 85.

FIG. 6 shows a perspective view of the elevator apparatus 110.

The elevator apparatus 110 has a roller carriage 220 and an elevator unit 225, which is arranged on the roller carriage 220. The roller carriage 220 is arranged on the rail arrangement 150 and can be moved along the rail arrangement 150. The elevator unit 225 is arranged on the roller carriage 220.

In addition, the elevator unit 225 may be enclosed by an elevator enclosure 230. The elevator unit 225 has, for example, at least one first winch 235, which is designed to wind or unwind one or more first cables 240, for example via a first deflection means 237, and to raise or lower the working platform 100 connected to the first cable 240. Several first cables 240 can redundantly hold the working platform 100.

The elevator apparatus 110 is displaceable along the rail arrangement 150 in the x-direction between the operating position and the installation position (cf. FIG. 2). The elevator apparatus 110 can be arranged in the installation position, for example between the two second attachment points 160.

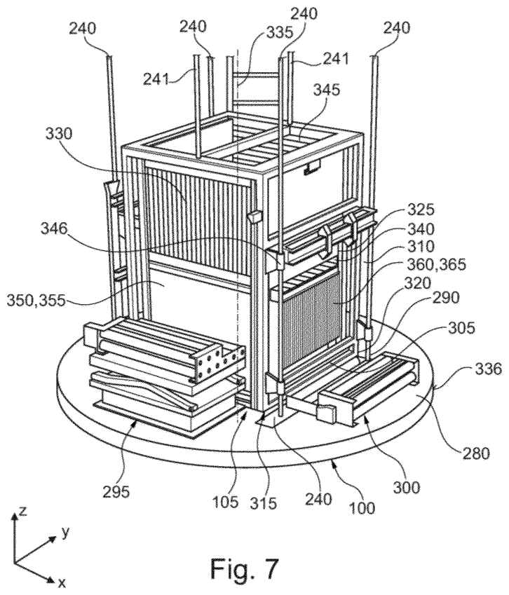

FIG. 7 shows a section of a perspective view of the working platform 100 and the transport apparatus 105, wherein the working platform 100 is only partially shown in FIG. 7.

The working platform 100 has a substantially circular center segment 280, wherein additional fold-in and fold-out bottom portions 285 can be arranged on the center segment 280 (shown in FIG. 2) in order to vary an outer diameter of the working platform 100. A maximum outer diameter of the center segment 280 is smaller here than a minimum diameter of the converter opening 45. The first cable 240 is attached to the center segment 280. Preferably, the first cable 240 is arranged at each of four suspension points 290 of the center segment 280, wherein the suspension points 290 are arranged offset from one another in order to ensure an alignment and position of the center segment 280 of the working platform 100 in a defined manner by means of the cables 240. In particular, for example, the four suspension points 290 prevent the working platform 100 from tilting.

The transport apparatus 105 has at least a first removal table 295, a second removal table 300, a first roller table 305, a carrier frame 310, a further elevator unit 315, a support element 320 and preferably a second roller table 325 and a housing 330.

The further elevator unit 315 may, for example, be integrated in the elevator apparatus 110 in the exemplary embodiment. The further elevator unit 315 has, for example, at least one second winch 236 (cf. FIG. 6, schematically indicated), which is designed to wind or unwind at least one second cable 241 (cf. FIG. 6, schematically indicated) and to raise or lower the carrier frame 310 connected to the second cable 241, for example via a second deflection means (not shown). The carrier frame 310 is connected to the top of the second cable 241.

The first removal table 295, in the circumferential direction relative to an axis 335, which runs parallel to the z-axis and can be a center axis of the converter opening 45, is arranged offset in the circumferential direction relative to the second removal table 300. In this case, the first removal table 295 and the second removal table 300 are arranged in the circumferential direction radially inwardly adjacently to an outer circumferential side 336 of the center segment 280.

The carrier frame 310 is substantially cubic in shape and encloses a first transport space 340 and preferably a second transport space 345, wherein the second transport space 345 is arranged above the first transport space 340 in the z-direction. On the underside, the first transport space 340 is delimited by the first roller table 305. In the z-direction, the second roller table 325 is arranged between the first transport space 340 and the second transport space 345, so that the first transport space 340 is delimited on the upper side in the z-direction by the second roller table 325. On the lower side, the second roller table 325 delimits the second transport space 345. It is noted that it is of course possible to dispense with one of the two transport spaces 340, 345, in particular the second transport space 345, and the second roller table 325. The first roller table 305 and the second roller table 325 are mechanically connected to the carrier frame 310. Furthermore, the carrier frame 310 is movably guided in the z-direction by means of a guide 346 on the first cable 240.

The housing 330 has a first housing opening 350 at least on the first side surface facing the first removal table 295, wherein the first housing opening 350 can be closed by means of a first door 355, which is designed, for example, as a lift door. The first housing opening 350 can connect laterally to both transport spaces 340, 345 in the z-direction. On a second side surface of the housing 330 arranged relative to the second removal table 300, the housing 330 has a second housing opening 360, which can be closed by a second door 365.

FIG. 8 shows a perspective view of the transport apparatus 105, wherein numerous components have been omitted for reasons of clarity.

In FIG. 8, in particular, the first door 355 and, in part, the housing 330 are not shown in order to see the first and second transport space 340, 345. The first and second roller tables 305, 325 are only shown schematically.

The first roller table 305 can have an unloading opening 366, which is, for example, square in plan view. The unloading opening 366 can also be dispensed with in the first roller table 305. The unloading opening 366 can be arranged approximately in the central position of the first roller table 305 and can extend, for example, over half a width of the first roller table 305. The unloading opening 366 is used, for example, to unload the first transport space 340 downward.

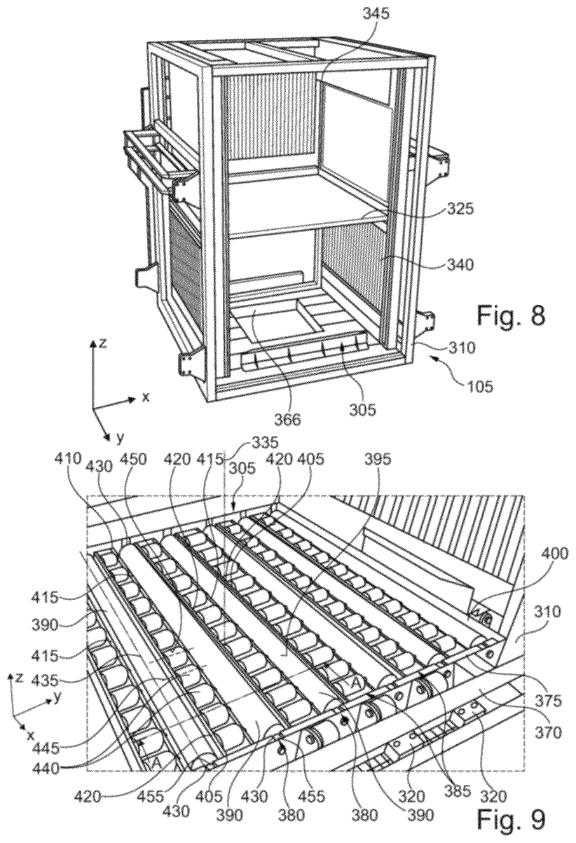

FIG. 9 shows a detail of the first roller table 305 shown in FIG. 8, wherein in FIG. 9 the unloading opening 366 in the first roller table 305 is omitted.

The first roller table 305 has a first roller frame 370, a second roller frame 375, a first roller arrangement 380 and a second roller arrangement 385. The first roller arrangement 380 has at least two first rollers 390. In FIG. 9, a plurality of first rollers 390 of the first roller arrangement 380 are provided, which are spaced apart from each other in the y-direction. The first rollers 390 have a substantially identical diameter. On the handling side, each of the first rollers 390 has a first rolling surface 395. The first roller 390 extends substantially in the x-direction over the entire inner width of the first roller frame 370.

The first roller frame 370 is mechanically connected to the outside of the carrier frame 310. In the plan view, the first roller frame 370 is substantially rectangular in shape. The first roller frame 370 delimits a receiving space 400 on the inside, in which the second roller frame 375 is received. The first roller frame 370 thus surrounds the second roller frame 375 on the circumferential side. The second roller frame 375 can rest against the outside of the first roller frame 370, as a result of which the second roller frame is guided by the first roller frame 370.

The second roller frame 375 has a first web 405 and a second web 410 arranged opposite in the x-direction. The first and second webs 405, 410 are substantially plate-like in design and each extend in an xz-plane. The first web 405 and the second web 410 are each connected to one another by a plurality of first and second transverse webs 415, 420 arranged spaced apart from one another in the y-direction. The first and second transverse webs 415, 420 are plate-like and extend substantially in a yz-plane. The first and second transverse webs 415, 420 are arranged alternately to one another. The first roller 390 is arranged between the first transverse web 415 and the second transverse web 420. The first roller 390 passes through a feedthrough 430 in the first web 405 and opposite in the x-direction in the second web 410 and is attached to the first roller frame 370 so as to be rotatable about a first axis of rotation 435. The first axis of rotation 435 extends substantially parallel to the x-axis and is thus aligned perpendicular to the axis 335.

A plurality of second rollers 440 are arranged between the second transverse web 420 and a further first transverse web 415. The second rollers 440 are arranged on a side of the second transverse web 420 facing away from the first roller 390. The second rollers 440 are designed to be significantly shorter in their main direction of extent than the first roller 390. The second rollers 440 are attached to the second and further first transverse web 420, 415 so as to be rotatable about a second axis of rotation 445. The second axis of rotation 445 extends substantially in the y-direction and is thus aligned perpendicular to the first axis of rotation 435 and to the axis 335. The second roller 440 has a second rolling surface 450 on the circumferential side. The second rolling surface 450 is cylindrical in shape and extends around the second axis of rotation 445.

The feedthrough 430 can be formed here as a slot running in the z-direction in the web 405, 410. The fastening of the first roller 390 can, for example, be formed between the first rolling surface 395 and the first roller frame 370 in a pin-like manner in a portion 455 of the first roller 390, so that the feedthrough 430 forms a slotted guide in conjunction with the portion 455.

In the z-direction along the axis 335, the second roller frame 375 can be moved relative to the first roller frame 370 between a first position and a second position. In the movement between the first position and the second position, the first roller frame 370 guides the second roller frame 375 in the x-direction and/or in the y-direction. In the first position, as shown in FIG. 9, the second roller frame 375 is lowered in the z-direction relative to the second position. In the first position, the first rolling surfaces 395 each project beyond the second rollers 440 with the second rolling surface 450 in their uppermost line.

At least one, preferably several, support elements 320 arranged at a defined distance from one another are arranged on the underside between the transport apparatus 105 and the center segment 280. In the first position, the second roller frame 375 is arranged at a distance from the support element 320. As a result, the second roller frame 375 is lowered downward and rests in the first roller frame 370. For this purpose, in particular the first and second webs 405, 410 can engage and abut in a groove provided for this purpose in the first roller frame 370. In the embodiment shown in FIG. 8, for example, the first and second roller arrangements 380, 385 are arranged laterally adjacently to the removal opening 366.

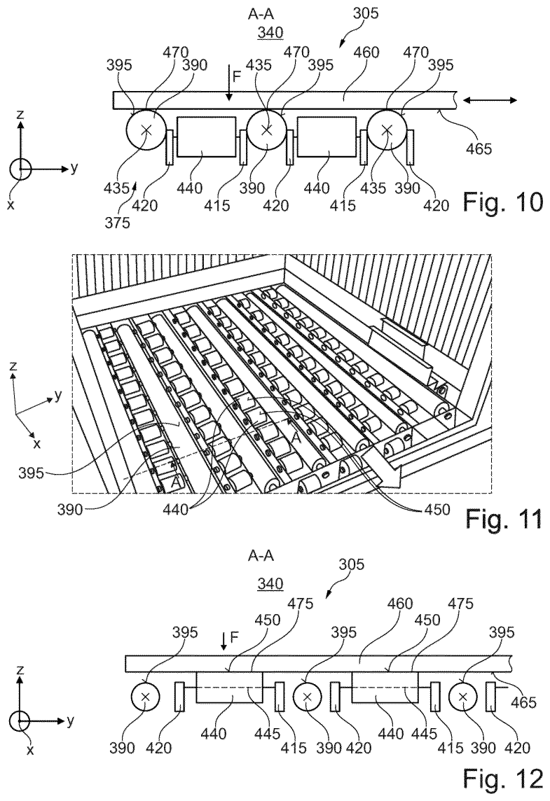

FIG. 10 shows a sectional view along a sectional plane A-A shown in FIG. 9 through the first roller table 305.

A first item to be transported 460 is placed in the first transport space 340. The first item to be transported 460 can, for example, be one or more pallets with lining bricks. People can also be transported instead of the pallet. The first item to be transported 460 is schematically indicated in FIG. 10 as a pallet with lining bricks. The first item to be transported 460 has a first underside 465, which extends substantially in an xy-plane. The first underside 465 can be flat or at least partially flat, as in the case of a pallet.

In the first position of the second roller frame 375, the first rollers 390 are raised relative to the second rollers 440. In this case, the first rolling surface 395 has a first rolling contact 470 with the first underside 465. Theoretically, the first rolling contact 470 is linear and runs substantially in the x-direction. The first rolling contact 470 carries the first item to be transported 460 through the first roller frame 370. In this case, only a force F from the first item to be transported 460 is supported on the first roller frame 370 via the first rollers 390. The force F can be further transmitted from the first roller frame 370 to the carrier frame 310. Due to the rotatable mounting of the first rollers 390 about the first axis of rotation 435, the first item to be transported 460 can be moved in the y-direction onto the first roller table 305. In the x-direction, movement is blocked by the first roller 390 resting on the first item to be transported 460 and the support of the first roller 390 in the axial direction on the first roller frame 370.

FIG. 11 shows the detail of the first roller table 305 shown in FIG. 9.

In the second position, the second roller frame 375 rests on the support element 320 and is raised by the support element 320 (concealed in FIG. 11). As a result, in FIG. 11 the second roller frame 375 is raised in the second position and relative to the first position (cf. FIG. 9). In the second position, the second rolling surface 450 of the second rollers 440 thus protrudes above the first rolling surface 395 of the first roller 390.

FIG. 12 shows a sectional view along the sectional plane A-A shown in FIG. 11 through the first roller table 305.

In the second position, the second rolling surface 450 of the second roller 440 is in a second rolling contact 475 with the first underside 465 of the first item to be transported 460. The second rolling contact 475 is line-shaped from a theoretical point of view or, in reality, the second rolling contact 475 has a small extent in the x-direction.

The first rolling surface 395 of the first roller 390 is arranged at a distance from the first underside 465 in each case. In the second position, the first item to be transported 460 is thus movable in the x-direction on the first roller table 395 due to the rotatable mounting of the second roller 440 about the second axis of rotation 445.

The first item to be transported 460 is prevented from falling out of the first transport space 340 by the fact that the doors 355, 365 are closed when the first transport space 340 is moved, thereby blocking the first item to be transported 460 from sliding out through the doors 355, 365.

In addition, further securing means may be provided to block movement of the first item to be transported 460 on the first roller table 305.

The force F is transmitted from the second roller 440 via the bearing of the second roller 440 to the first and second webs 415, 420. From there, the force F is transmitted via the first and second webs 405, 410 to the support element 320 on the center segment 280.

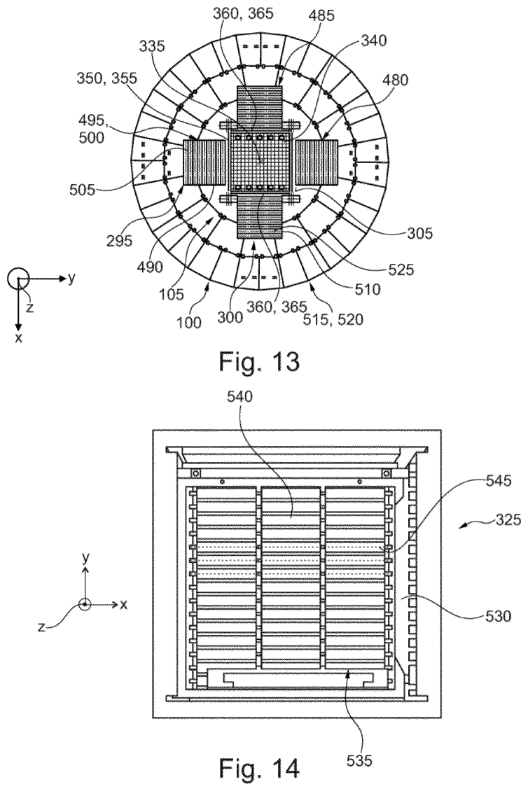

FIG. 13 shows a top view of the working platform 100 and the transport apparatus 105.

In the embodiment, the transport apparatus 105 by way of example has, in addition to the first removal table 295, a third removal table 480 arranged opposite in the y-direction. The third removal table 480 is arranged identically to the first removal table 295. In addition, the transport apparatus 105 also has a fourth removal table 485 arranged opposite the second removal table 300 in the x-direction. The fourth removal table 485 is designed here identically to the second removal table 300.

The first to fourth removal tables 295, 300, 480, 485 can also be designed identically to one another. For example, the removal tables 295, 300, 480, 485 are arranged around the first roller table 305 with an angular offset of approximately 90° in the circumferential direction around the axis 335. The first removal table 295 has a third roller frame 490 and a third roller arrangement 495 comprising third rollers 500, wherein the third rollers 500 are each mounted to rotate about a third axis of rotation 505. The third axis of rotation 505 is aligned parallel to the x-axis and thus runs parallel to the first axis of rotation 435.

The second removal table 300 is arranged, for example, rotated by 90° relative to the first removal table 295 on the working platform 100. The second removal table 300 has a fourth roller frame 510 and a fourth roller arrangement 515 with at least one fourth roller 520, which is mounted rotatably about a fourth axis of rotation 525 in each case on the fourth roller frame 510. The fourth axis of rotation 525 is aligned parallel to the second axis of rotation 445.

The first housing opening 350 and the first door 355 are arranged, respectively, between the first transport space 340 and the first removal table 295, and the first transport space 340 and the third removal table 480. The second housing opening 360 and the second door 365 are arranged, respectively, between the first transport space 340 and the second removal table 300 and the fourth removal table 485.

If the first roller table 305 is in the first position and the first door 355 is opened, the first item to be transported 460 can be pulled out of the first transport frame onto either the first removal table 295 or the third removal table 480. The first item to be transported 460 can thus be stored on the first removal table 295 or the third removal table 480 and/or the first item to be transported 460 can be unloaded from the first and/or third removal table 295, 480, for example in order to renew the lining 60. In particular, the first material to be transported 460 may comprise bricks of the lining 60.

If, as shown in FIGS. 11 and 12, the first roller table 325 is moved to the second position, the second roller frame 375 is raised in the second position relative to the first roller frame 370 by the support element 320. In this case, the second rollers 440, as shown in FIG. 12, come into contact with the first underside 465 and the first item to be transported 460 can be removed from the first roller table 305 in the x-direction instead of in the y-direction. For this purpose, for example, the second door 365 is opened and the first item to be transported 460 is pulled from the first transport space 340 onto the second removal table 300 or onto the fourth removal table 485 in the x-direction.

Due to the four removal tables 295, 300, 480, 485 arranged on the working platform 100, sufficient lining material can be made available so that the waiting time of the bricklayers for installing the lining 60 is kept to a minimum and sufficient material, in particular bricks, is always available to produce the lining 60.

FIG. 14 shows a top view of the second roller table 325 of the transport apparatus 105.

The second roller table 325 is designed similarly to the first to fourth removal tables 295, 300, 480, 485 and has, in addition to a fifth roller frame 530, a fifth roller arrangement 535 with fifth rollers 540, which are rotatably mounted on the fifth roller frame 530 so as to be rotatable about a fifth axis of rotation 545. The fifth axis of rotation 545 is aligned parallel to the x-axis and the first axis of rotation 435.

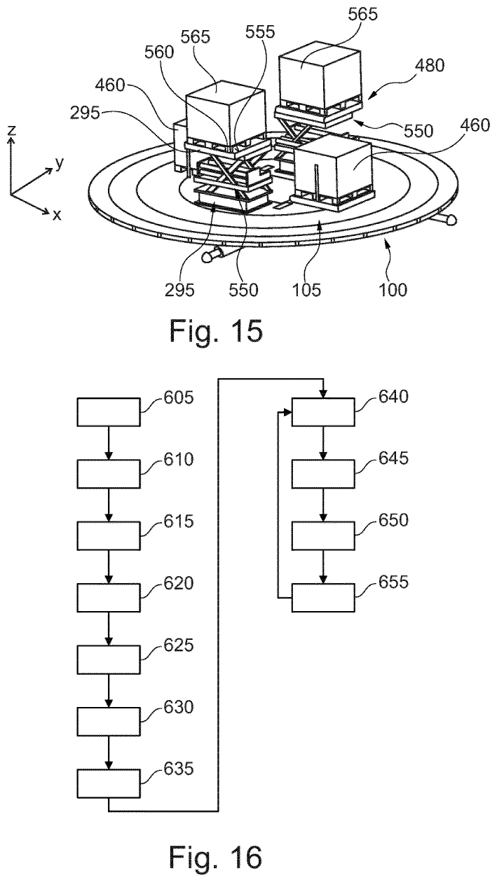

FIG. 15 shows a perspective view of the transport apparatus 105 on the working platform 100.

In addition, the first removal table 295 and/or the third removal table 480 can have a lifting unit 550, wherein the lifting unit 550 is designed, for example, as a scissor lift. The lifting unit 550 can move the first removal table 295 between a first removal position and a second removal position, wherein in the first removal position a third rolling surface 555 of the third roller 500 has a third rolling contact 560 on the first underside 465 of the first item to be transported 460. The third rolling contact 560 and the first rolling contact 470 can be arranged in a common xy-plane.

In order to remove a second item to be transported 565 from the second transport space 345, the lifting unit 550 can lift the first removal table 295 so that the first removal table 295 is arranged substantially at the same height as the second roller table 325. This makes it particularly easy to pull the second item to be transported 565 out of the second transport space 345, wherein the third rolling surface 555 rolls along a second underside of the second item to be transported 565. The first and second items to be transported 460, 565 can, for example, be identical to one another.

Furthermore, the lifting unit 550 can be used to lift the items to be transported 460, 565 stored on the first removal table 295 to an ergonomic working height. In particular, for example, the first or second items to be transported 460, 565 can be raised or lowered accordingly so that the bricks can be unloaded from the first removal table 295 at an ideal working height and the lining 60 can thus be renewed.

Likewise, as shown in FIG. 15, the third removal table 480 can also be provided with the lifting unit 550. As a result, the second item to be transported 565 can be removed from the second transport space 345 on both sides in the y-direction on two sides of the working platform 100.

This means that a large amount of material can be stored on the working platform 100 particularly quickly, for example for installing the lining 60, so that the lining 60 can be replaced by a large number of people. This means that the lining 60 can be replaced particularly quickly. Furthermore, the distances from the removal table 295, 300, 480, 485 to the lining 60 are particularly short. This further reduces the working time required to produce the lining 60.

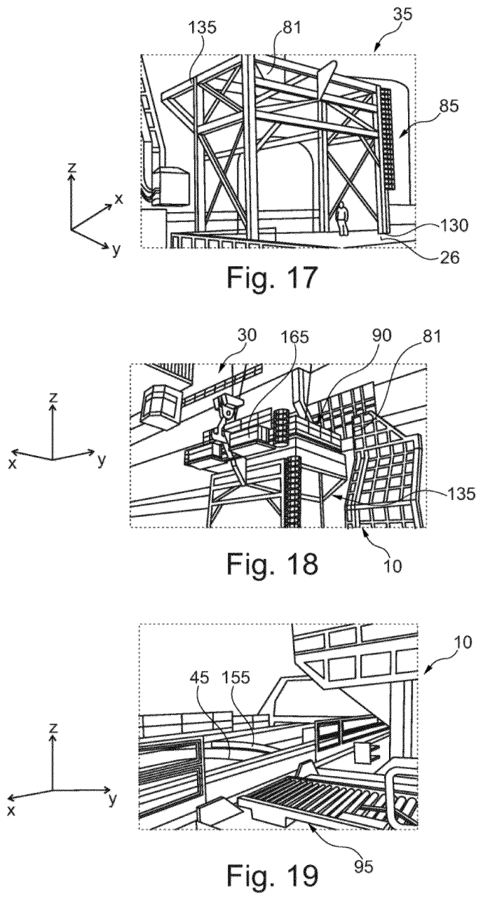

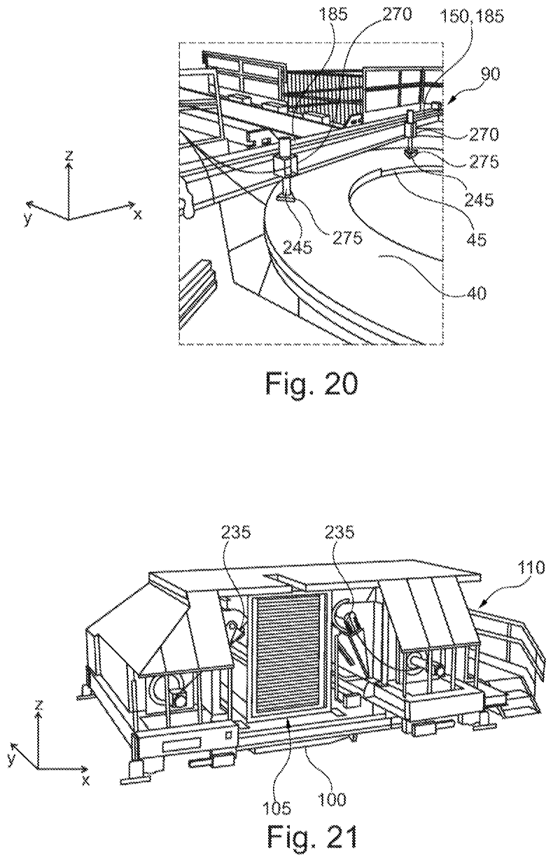

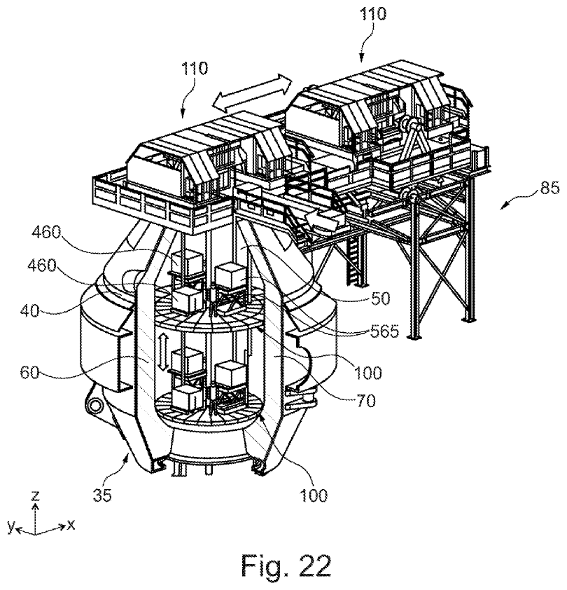

FIG. 16 shows a flow diagram of a method for renewing the lining 60. FIG. 17 shows a perspective view of the base frame 85 at the converter 35 during a second method step 610. FIG. 18 shows a perspective view of the system 10 during a third method step 615. FIG. 19 shows a perspective view of the system 10 during a fourth method step 620. FIG. 20 shows a perspective view of the system 10 during a fifth method step 625. FIG. 21 shows a perspective view of the elevator apparatus 110 together with the transport apparatus 105 and the working platform 100 during a sixth method step 630. FIG. 22 shows a perspective view of the system 10.

In a first method step 605, the base frame 85, the rail group 90, the elevator apparatus 110, the feed apparatus 95 as well as the transport apparatus 105 and the working platform 100 are provided.

In the second method step 610 (cf. FIG. 17), after the working space 70 of the converter vessel 40 has been emptied and cooled, the enclosure opening 81, which is normally closed during operation of the converter 35, is opened. Furthermore, on the side of the converter 35 facing the enclosure opening 81, the base frame 85 is set up on the building floor 36 of the building 25 in the second method step 610. To transport the base frame 85 from a storage station to the converter 35, the crane 30 can be suspended at the first attachment point 140 and the crane 30 transports the base frame 85, holding it at the first attachment point 140, to in front of the converter 35. The base frame 85 is positioned on the side facing the enclosure opening 81 in front of the converter vessel 40 (looking in the x-direction). Furthermore, in the second method step 610, the fastening plate 130 is reversibly detachably fastened, for example, to the building floor 26 of the building 25. The base frame 85 is oriented relative to the converter vessel 40 in such a way that the support frame unit 135 engages in the enclosure opening 81.

In a third method step 615 (cf. FIGS. 18 and 19), the rail group 90 is transported from the storage location by means of the crane 30 and placed on top of the support frame unit 135 in such a way that the counterweight 165 is arranged on a side of the rail group 90 facing away from the enclosure opening 81. The rail group 90 projects into the enclosure opening 81 and is oriented so that the working opening 155 and the converter opening 45 are aligned with each other (cf. FIG. 19).

In a fourth method step 620 (cf. FIG. 20), the rail group 90 is leveled and aligned by the leveling apparatus 166. The first leveling element 245 rests with the second side 275 on the converter vessel 40. The second side 275 is moved out of the first leveling element 245 until the rail group 90, in particular the rail arrangement 150, is horizontally aligned and the converter opening 45 is arranged between the two rails 185.

If this is the case, the rail group 90 is reversibly detachably connected to the support frame unit 135 by means of the first connection. By resting and leveling the rail group 90 on the converter vessel 40 and attaching it to the base frame 85, it is possible to prevent the rail group 90 from tipping over or slipping off the converter 35.

In a fifth method step 625 following the fourth method step 620, the feed apparatus 95 is positioned next to the working opening 155. The turntable 210, which is arranged on the side of the feed apparatus 95 facing away from the working opening 155, can for example be arranged on the enclosure 80 or the converter frame 75 of the converter 35. Furthermore, the feed apparatus 95 is leveled in the same way as the rail group 90, but with respect to both the converter vessel 40 and the enclosure 80.

In a sixth method step 630 following the fifth method step 625, the elevator apparatus 110 and the working platform 100 and transport apparatus 105 connected to the elevator apparatus 110 are provided and placed on the rail group 90 in the installation position (cf. FIG. 22). In the installation position, however, the elevator apparatus 110 is arranged at a distance from the converter opening 45. When the working platform 100 and the transport apparatus 105 are provided, the working platform 100 is positioned directly on the underside of the elevator apparatus 110. The first and second transport spaces 340, 345 are retracted into the elevator apparatus 110 (cf. FIG. 21).

In a seventh method step 635 following the sixth method step 630, the elevator apparatus 110 is moved together with the working platform 100 and the transport apparatus 105 from the installation position along the x-axis into the operating position (cf. FIG. 22).

After reaching the operating position, the first cable 240 is unwound in an eighth method step 640 by means of the first winch 235 and the working platform 110 is retracted into the working space 70 via the converter opening 45 at the top. In FIG. 22, the working platform 100 is shown at different working heights. The height position of the working platform 100 in the working space 70 can be variably changed by the first winch 235 and the first cable 240.

In a ninth method step 645 following the eighth method step 640, the first and second items to be transported 460, 565 are delivered, for example by means of a forklift truck. The first item to be transported 460 is placed on the turntable 210. The orientation of the first item to be transported 460 can be aligned as desired on the turntable 210. Via the turntable 210 and the roller conveyor 215, the first item to be transported 460 is pushed into the first transport space 340 via the open first door 355. The second roller frame 375 is in the first position, so that the second rollers 440 are lowered and the first item to be transported 460 can be pushed into the first transport space 340 in the y-direction.

In a tenth method step 650 following the ninth method step 645, the carrier frame 310 and the first roller table 305 are lowered by the further elevator unit 315 until the first roller table 305 and the roller conveyor 215 are arranged substantially in a common plane. In this case, the first roller table 305 is in a third position, which is above the first and second positions. The first housing opening 350 is open, so that the first item to be transported 460 can be pushed from the roller conveyor 215 onto the first roller table 305 into the first transport space 340. Similarly, the second roller table 325 can be lowered by the further elevator unit 315 until the second roller table 325 and the roller conveyor 215 are arranged substantially in a common plane. As a result, the second item to be transported 565 can be pushed onto the second roller table 325. As a result, the transport apparatus 105 is thus loaded with two items to be transported 460, 565, for example two pallets of bricks.

In an eleventh method step 655 following the tenth method step 650, the carrier frame 310 and the roller tables 305, 325 attached thereto are lowered downward in the direction of the working platform 100 by the further elevator unit 315. Depending on the loading of the first to fourth removal table 295, 300, 480, 485, the first roller table 305 is brought into either the first or second position by the second winch 236 and either the first door 355 or the second door 365 is opened so that the first or second housing opening 350, 360 is continuous. The first item to be transported 460 is pushed via one of the two housing openings 350, 360 onto one of the four removal tables 295, 300, 480, 485, for example onto the second removal table 300.

Similarly, the first or third unoccupied removal table 295, 480 is raised by the respective associated lifting unit 550 to such an extent that the first or third removal table 295, 480 are arranged substantially at a common height with the second roller table 325. For example, the third removal table 480 can be lifted and the second item to be transported 565 can be moved from the second transport space 345 to the third removal table 480.

After the item to be transported 460, 565 has been removed, either the first and/or second transport space 340, 345 can be filled with waste, for example, or can be pulled upward, empty, through the working opening 155 into the elevator apparatus 110. The height position of the working platform 100 is maintained and only the carrier frame 310 is drawn into the elevator apparatus 110.

The eighth to eleventh method steps 640 to 655 are repeated until the lining 60 has been installed with the material transported in the first and second transport spaces 340, 345 for the lining 60. If, for example, as explained above, the first and third removal tables 295, 480 are occupied with the first and second transport material 460, 565, the transport material 460, 565 transported in the first and second transport spaces 340, 345 can be drawn out of the second housing opening 360 onto the second and fourth removal tables 300, 485, for example, by opening the second door 365.

After completion of the lining 60, the lining machine 20 is disassembled in the reverse order of the first to seventh method steps 605-635 and the converter 35 is put back into operation. The process may be repeated for the same converter 35 or for a different converter 35 to renew the lining of the same converter 35 with the lining machine 20 again, or to renew the lining of the different converter 35.

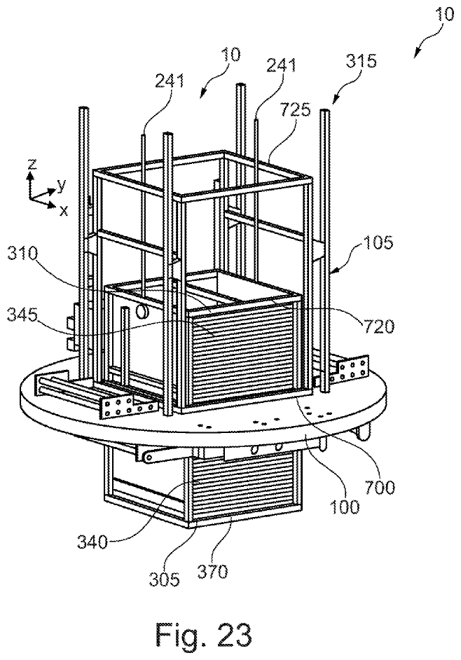

FIG. 23 shows a perspective view of the transport apparatus 105 and the working platform 100 in a development of the system 10.

In the development, the carrier frame 310 can be designed in two parts. The carrier frame 310 has an inner frame 720 and an outer frame 725, wherein the outer frame 725 guides the inner frame 720 in the xy-direction by means of a guide means. The inner frame 720 is connected to the second cable 241. In a stop position of the guide means, in which it is located between the first and third position of the first roller table 305, the inner frame 720 carries the outer frame 725, which in turn is guided on the first cable 240 via the guide 346.

The further elevator unit 315 can lower the carrier frame 310 to a fourth position such that the inner frame 720 protrudes from the underside of the working platform 100. In the fourth position, the carrier frame 310 is arranged below the first to third positions. The outer frame 725 rests on the working platform 100 between the first position and the fourth position and the guide means guides the inner frame 720 in the lowering from the first position to the fourth position in the xy-direction through an opening 700 in the working platform 100.

In order to prevent the second roller frame 375 from resting on the support element 320 when the inner frame 720 is lowered through the opening 700, the support element 320 can be removed, for example by folding it down. The first roller frame 370 is mechanically connected to the inner frame 720. Preferably, at least the first transport space 340, preferably both transport spaces 340, 345 below the working platform 100 are fully accessible. This allows the transport space 340, 345 to be unloaded or loaded underneath the working platform. As a result, the lining material can also be provided quickly and reliably below the working platform 100, for example when installing a lining on a base of the converter 35, so that the lining can be constructed particularly quickly. As a result, the time required to renew the lining 60 is kept to a minimum.

### LIST OF REFERENCE SIGNS

10 system
15 production plant
20 lining machine
25 building
26 building floor
30 crane
35 converter
40 converter vessel
45 converter opening
50 converter chamber
55 first inner circumferential side
60 lining
65 second inner circumferential side
70 working space
75 converter frame
80 enclosure
81 enclosure opening
85 base frame
90 rail group
95 feed apparatus
100 working platform
105 transport apparatus
110 elevator apparatus
115 profiled beam
120 bracing
125 support
130 fastening plate
135 support frame unit
140 first attachment point
141 longitudinal beam
142 stop
143 cross member
144 swivel joint
145 connection platform
146 pin
147 joint receptacle
150 rail arrangement
155 working opening
160 second attachment point
165 counterweight
170 first leveling unit
171 second leveling unit
175 carrier frame
185 rail
190 work floor
195 fall protection means
200 first ladder
205 second ladder
210 turntable
215 roller conveyor
220 roller carriage
225 elevator unit
230 elevator enclosure
235 first winch
236 second winch
237 first deflection means
240 first cable
241 second cable
245 first leveling element
250 storage container
255 feed pump
260 first fluid line
265 second fluid line
270 first side
275 second side
276 second leveling element
280 center segment
285 bottom portions
290 suspension point
295 first removal table
300 second removal table
305 first roller table
310 carrier frame
315 further elevator unit
320 support element
325 second roller table
330 housing
335 axis
336 outer circumferential side
340 first transport space
345 second transport space
346 guide
350 first housing opening
355 first door
360 second housing opening
365 second door
366 unloading opening
370 first roller frame
375 second roller frame
380 first roller arrangement
385 second roller arrangement
390 first roller
395 first rolling surface
400 receiving space
405 first web
410 second web
415 first transverse web
420 second transverse web
425 third transverse web
430 feedthrough
435 first axis of rotation
440 second roller
445 second axis of rotation
450 second rolling surface
455 portion
460 first item to be transported
465 first underside
470 first rolling contact
475 second rolling contact
480 third removal table
485 fourth removal table
490 third roller frame
495 third roller arrangement
500 third roller
505 third axis of rotation
510 fourth roller frame
515 fourth roller arrangement
520 fourth roller
525 fourth axis of rotation
530 fifth roller frame
535 fifth roller arrangement
540 fifth roller
545 fifth axis of rotation
550 lifting unit
555 third rolling surface
560 third rolling contact
565 second item to be transported
605 first method step
610 second method step
615 third method step
620 fourth method step
625 fifth method step
630 sixth method step
635 seventh method step
640 eighth method step
645 ninth method step
650 tenth method step
655 eleventh method step
700 opening
720 inner frame
725 outer frame
F force

1. A transport apparatus for a lining machine,
wherein the transport apparatus has a first transport space and a first roller table arranged below the first transport space for transporting a first item to be transported,
wherein the first roller table comprises a first roller frame, and a first roller arrangement with at least two first rollers, wherein
the first roller table has a second roller frame and a second roller arrangement with at least one second roller,
wherein the second roller frame is arranged in the first roller frame so as to be movable along an axis between a first position and a second position different from the first position,
wherein each of the first rollers is attached to the first roller frame so as to be rotatable about a first axis of rotation which is inclined with respect to the axis,
wherein the second roller is arranged between the two first rollers,
wherein the second roller is mounted on the second roller frame so as to be rotatable about a second axis of rotation, which is inclined with respect to the axis and aligned with the first axis of rotation,
wherein the first roller has a first rolling surface on the circumferential side and the second roller has a second rolling surface on the circumferential side,
wherein, in the first position of the second roller frame, the second roller is arranged recessed between two first rollers and the first rolling surface projects beyond the second rolling surface in the direction of the axis,
wherein in the second position the second roller frame is raised relative to the first position and the second rolling surface projects beyond the first rolling surface in the direction of the axis.

2. The transport apparatus as claimed in claim 1,
having a first removal table and a second removal table offset in the circumferential direction relative to the axis,
wherein the first removal table has a third roller arrangement with at least one third roller and a third roller frame,
wherein the third roller is attached to the third roller frame so as to be rotatable about a third axis of rotation,
wherein the second removal table has a fourth roller arrangement with at least one fourth roller and a fourth roller frame,
wherein the fourth roller is attached to the fourth roller frame so as to be rotatable about a fourth axis of rotation,
wherein the third axis of rotation is aligned parallel to the first axis of rotation and the fourth axis of rotation is aligned parallel to the second axis of rotation.

3. The transport apparatus as claimed in claim 2,
having a housing with a closable first housing opening and a closable second housing opening which is arranged offset to the first housing opening in the circumferential direction relative to the axis-,
wherein the housing encloses the first transport space at least in portions,
wherein the first housing opening is arranged between the first removal table and the first transport chamber and the second housing opening is arranged between the second removal table and the first transport chamber.

4. The transport apparatus as claimed in claim 1,
having a second transport space and a second roller table,
wherein the second roller table is arranged offset along the axis relative to the first roller table and closes off the first transport space at the top and delimits the second transport space at the bottom,
wherein the second roller table has a fifth roller frame and a fifth roller arrangement with at least one fifth roller,
wherein the fifth roller is attached to the fifth roller frame so as to be rotatable about a fifth axis of rotation,
wherein the fifth axis of rotation is arranged parallel to the first axis of rotation.

5. The transport apparatus as claimed in claim 4,
wherein the first removal table has a lifting unit,
wherein the lifting unit is connected to the third roller frame and is designed to move the third roller frame between a first removal position and a second removal position different from the first removal position,
wherein, in the first removal position, the first roller arrangement and the third roller arrangement are arranged substantially at the same height,
wherein, in the second removal position, the fifth roller arrangement and the third roller arrangement are arranged substantially at the same height.

6. The transport apparatus as claimed in claim 1,
wherein the first roller table has an unloading opening,
wherein the first transport space is accessible from below through the removal opening and the first item to be transported can be unloaded through the removal opening,
wherein at least the first roller arrangement and the second roller arrangement are arranged laterally of the removal opening.

7. A lining machine for renewing a lining of a converter through a converter opening,
wherein the lining machine comprises a base frame, a rail group, a feed apparatus, an elevator apparatus and a working platform,
wherein the rail group is mechanically attached to the base frame,
wherein the rail group has at least one rail arrangement,
wherein the elevator apparatus comprises a roller carriage and an elevator unit arranged on the roller carriage,
wherein the roller carriage is arranged on the rail arrangement so as to be movable between an installation position and an operating position,
wherein the elevator unit is connected to the working platform and is designed to lower the working platform into the converter via the converter opening,
wherein the feed apparatus has a roller conveyor which ends on one side at the elevator apparatus.

8. The lining machine as claimed in claim 7,
comprising a transport apparatus,
wherein the transport apparatus has a first transport space and a first roller table arranged below the first transport space for transporting a first item to be transported,
wherein the first roller table comprises a first roller frame, and a first roller arrangement with at least two first rollers, wherein
the first roller table has a second roller frame and a second roller arrangement with at least one second roller,
wherein the second roller frame is arranged in the first roller frame so as to be movable along an axis between a first position and a second position different from the first position,
wherein each of the first rollers is attached to the first roller frame so as to be rotatable about a first axis of rotation which is inclined with respect to the axis,
wherein the second roller is arranged between the two first rollers,
wherein the second roller is mounted on the second roller frame so as to be rotatable about a second axis of rotation, which is inclined with respect to the axis and aligned with the first axis or rotation,
wherein the first roller has a first rolling surface on the circumferential side and the second roller has a second rolling surface on the circumferential side,
wherein, in the first position of the second roller frame, the second roller is arranged recessed between two first rollers and the first rolling surface projects beyond the second rolling surface in the direction of the axis,
wherein the second position the second roller frame is raised relative to the first position and the second rolling surface projects beyond the first rolling surface in the direction of the axis,
wherein the transport apparatus has a further elevator unit,
wherein the further elevator unit 59 is connected to the first roller table and is configured to move the first roller table between the first position and the second position.

9. The lining machine as claimed in claim 8,
wherein the further elevator unit has a second winch,
wherein the second winch is mechanically connected to the first roller table by means of a second cable,
wherein the second winch is configured to wind or unwind the second cable to move the first pulley table between the first position and the second position.

10. The lining machine as claimed in claim 7,
wherein the rail group comprises a carrier frame and a leveling apparatus,
wherein the carrier frame is mechanically connected to the base frame,
wherein the rail arrangement is arranged on the carrier frame,
wherein the leveling apparatus has at least one first leveling unit,
wherein the first leveling unit comprises at least a first leveling element which is attached to the carrier frame on a first side,
wherein the first leveling element is designed to rest against a converter vessel on a second side facing away from the first side,
wherein the first leveling element is designed to be adjustable in such a way that a distance between the first side and the second side can be changed;
and/or
wherein the leveling apparatus has at least one second leveling unit,
wherein the second leveling unit comprises at least one second leveling element arranged on a third side of the base frame,
wherein the second leveling element rests against the connecting platform on a fourth side facing away from the third side,
wherein the second leveling element is designed to be adjustable in such a way that a distance between the third side and the fourth side can be changed in order to pivot the connecting platform relative to the base frame.

11. A system comprising a converter and a lining machine as claimed in claim 7,
wherein the converter has a converter vessel with a converter opening,
wherein the converter vessel encloses a converter chamber which is open at the top through the converter opening,
wherein the base frame is arranged laterally in front of the converter vessel,
wherein the rail group is arranged above the base frame and the converter opening,
wherein the elevator apparatus is arranged above the base frame in the installation position and above the converter opening in the operating position,
wherein the elevator apparatus is designed to lower the working platform into the converter chamber in the operating position.

12. The system as claimed in claim 11,
wherein the second side of the first leveling element rests on the converter vessel and supports the carrier frame against the converter vessel,
wherein the first leveling element is designed to align the carrier frame relative to the base frame and the converter vessel.

13. A method for operating a system as claimed in claim 11,
wherein the base frame is positioned in front of the converter,
wherein the rail group is placed on the base frame and the converter in such a way that the rail group extends at least in portions at the converter opening,
wherein the rail group is mechanically reversibly detachably connected to the base frame,
wherein the elevator apparatus is placed on the rail group in such a way that the roller carriage is positioned on the rail group in the installation position,
wherein the elevator apparatus is moved into the operating position,
wherein the feed apparatus is positioned on the rail group such that one end of the feed apparatus is positioned at the converter opening and the elevator apparatus,
wherein the working platform is lowered into the converter chamber via the converter opening.

14. The method as claimed in claim 13 with a lining machine for renewing a lining of a converter through a converter opening, wherein the lining machine comprises a base frame, a rail group, a feed apparatus, an elevator apparatus and a working platform,
wherein the rail group is mechanically attached to the base frame,
wherein the rail group has at least one rail arrangement,
wherein the elevator apparatus comprises a roller carriage and an elevator unit arranged on the roller carriage,
wherein the roller carriage is arranged on the rail arrangement so as to be movable between an installation position and an operating position,
wherein the elevator unit is connected to the working platform and is designed to lower the working platform into the converter via the converter opening,
wherein the feed apparatus has a roller conveyor which ends on one side at the elevator apparatus,
a transport apparatus,
wherein the transport apparatus has a first transport space and a first roller table arranged below the first transport space for transporting a first item to be transported,
wherein the first roller table comprises a first roller frame, and a first roller arrangement with at least two first rollers,
wherein the first roller table has a second roller frame and a second roller arrangement with at least one second roller,
wherein the second roller frame is arranged in the first roller frame so as to be movable along an axis between a first position and a second position different from the first position,
wherein each of the first rollers is attached to the first roller frame so as to be rotatable about a first axis of rotation which is inlined with respect to the axis,
wherein the second roller is arranged between the two first rollers,
wherein the second roller is mounted on the second roller frame so as to be rotatable about a second axis of rotation, which is inclined with respect to the axis and aligned with the first axis of rotation,
wherein the first roller has a first rolling surface on the circumferential side and the second roller has a second rolling surface on the circumferential side,
wherein, in the first position of the second roller frame, the second roller is arranged recessed between two first rollers and the first rolling surface projects beyond the second rolling surface in the direction of the axis,
wherein in the second position the second roller frame is raised relative to the first position and the second rolling surface projects beyond the first rolling surface in the direction of the axis,
wherein the transport apparatus has a further elevator unit,
wherein the further elevator unit is connected to the first roller table and is configured to move the first roller table between the first position and the second position,
wherein the first roller table is moved to a third position,
wherein the first item to be transported is fed to the feed apparatus; and
the first item to be transported is moved on the roller conveyor to the first roller table,
wherein the first item to be transported is moved on the first roller table (305) into the first transport space,
wherein the first roller rolls along the first item to be transported,
wherein the elevator apparatus lowers the first roller table to the first position or to the second position,
wherein in the first position the first item to be transported is removed from the first transport space in a first direction, or
wherein in the second position the first item to be transported is removed from the first transport space in a second direction.

15. The method as claimed in claim 13 and a lining machine for renewing a lining of a converter through a converter opening, wherein the lining machine comprises a base frame, a rail group, a feed apparatus, an elevator apparatus and a working platform,
wherein the rail group is mechanically attached to the base frame,
wherein the rail group has at least one rail arrangement,
wherein the elevator apparatus comprises a roller carriage and an elevator unit arranged on the roller carriage,
wherein the roller carriage is arranged on the rail arrangement so as to be movable between an installation position and an operating position,
wherein the elevator unit is connected to the working platform and is designed to lower the working platform into the converter via the converter opening,
wherein the feed apparatus has a roller conveyor which ends on one side at the elevator apparatus,
a transport apparatus,
wherein the transport apparatus has a first transport space and a first roller table arranged below the first transport space for transporting a first item to be transported,
wherein the first roller table comprises a first roller frame, and a first roller arrangement with at least two first rollers,
wherein the first roller table has a second roller frame and a second roller arrangement with at least one second roller,
wherein the second roller frame is arranged in the first roller frame so as to be movable along an axis between a first position and a second position different from the first position,
wherein each of the first rollers is attached to the first roller frame so as to be rotatable about a first axis of rotation which is inclined with respect to the axis,
wherein the second roller is arranged between the two first rollers,
wherein the second roller is mounted on the second roller frame so as to be rotatable about a second axis of rotation, which is inclined with respect to the axis and aligned with the first axis of rotation,
wherein the first roller has a first rolling surface on the circumferential side and the second roller h as a second rolling surface on the circumferential side,
wherein, in the first position of the second roller frame, the second roller is arranged recessed between two first rollers and the first rolling surface projects beyond the second rolling surface in the direction of the axis,
wherein in the second position the second roller frame is raised relative to the first position and the second rolling surface projects beyond the first rolling surface in the direction of the axis,
wherein the transport apparatus has a further elevator unit,
wherein the further elevator unit is connected to the first roller table and is configured to move the first roller table between the first position and the second position,
wherein the first roller table is lowered through an opening of the working platform into a fourth position below the working platform in such a way that the first transport space is arranged below the working platform,
wherein the first transport space below the working platform is loaded and/or unloaded with the first item to be transported-.
